(19) United States
(12) Patent Application Publication
(10) Pub. No.: US 2026/0324887 A1
(43) Pub. Date: Oct. 22, 2026

(54) Alignment Face and Body Pillow

(71) Applicant: Melissa Schwartz, Erie, CO (US)

(72) Inventor: Melissa Schwartz, Erie, CO (US)

(21) Appl. No.: 19/486,297

(22) PCT Filed: Feb. 23, 2024
(86) PCT No.: PCT/US2024/017016

§ 371 Date: Nov. 20, 2025

Related U.S. Application Data
(60) Provisional application No. 63/503,615, filed on May 22, 2023.

(51) Int. Cl. A47G 9/10

(52) U.S. Cl. CPC A47G 9/10

(57) ABSTRACT

A pillow has a long, flexible core with a contiguous arrangement of a variable number of segmented, adjustable compartments that can be individually tailored to support the face and body of users with diverse body types and preferences, by supporting and aligning parts of the body to maximize comfort and alleviate points of pressure both in the body itself and on the surface that the body parts make contact with. The amount of filler may be increased or reduced in specific compartments.

### BACKGROUND OF THE INVENTION

### Field of the Invention

The present invention relates to long pillows that allow users to manually adjust the amount of supportive padding.

### Discussion of Related Art

The average person spends somewhere between 30% and 50% of their life laying down in bed either sleeping or relaxing while awake. Over this long span of time, the position we lay in can consistently either help us look and feel rested and restored or alternatively can cause a number of problems including pain such as soreness or even physical damage to the body ranging from cosmetic, such as advancing physical signs of aging, to more serious musculoskeletal effects that may denigrate bodily mobility.

A number of factors can cause the human body to be in discomfort even in a relaxed state such as laying down including injuries, excess weight, pregnancy etc. The cause of discomfort in many cases is unevenly distributed weight on points of pressure in and/or on the body. For example, someone may feel discomfort in their hips if they are laying on their side with both knees supported only by the surface they are laying on. In that case, one may attempt to alleviate the pressure on their hip flexor by holding a pillow between their legs, supporting their outer hip. In another example, one may feel discomfort if their head is unsupported and therefor unaligned with their spine which is why it is very common to place a pillow under one's head while sleeping. Yet another example is the pressure on one's various parts of the face that make heaviest contact with a pillow such as the cheekbone and mandible areas. Not only can the weight of one's head cause discomfort on these areas over time, but it can also cause creasing and stretching of the delicate skin in those areas which can lead to undesirable effects such as wrinkles, sagging and loose skin associated with aging.

### SUMMARY OF THE INVENTION

A long pillow that allows users to manually adjust the amount of supportive padding desired to sustain variable levels of support for areas of the face and body thereby alleviating of points of pressure. Due to its adjustable and flexible design, advantages of consistently using this pillow over time may include one or more of the following:

Alleviation of pain due to the support of the neck, back and joints that are commonly strained when misaligned for long enough periods of time, such as those in the hips and shoulders.

Mitigation of visual signs of aging on face, neck and chest such as sagging skin and wrinkles, especially lines around the eyes, forehead, nasal labial folds, mouth, neck and décolletage as well as jowls and eye hooding.

Increased energy throughout the day due to more comfortable and restorative periods of sleep.

Relief from sleep related health and comfort problems during pregnancy.

Increased comfort during bodywork sessions such as massage or acupuncture.

Relief from tinnitus during periods of use.

Reduced fatigue during sex and increased comfort and leverage for sexual positions.

Implementations can include one or more of the following:

A pillow constructed with a variable number of segmented, adjustable compartments that are aligned contiguously such that the pillow is longer than it is wide. This structure allows the pillow to be flexible such that it can be arranged and rearranged continually throughout the period of use as to accommodate a user's movements and subsequently alleviate changing points of pressure on their face and/or body.

A pillow with a core that consists of compartments that house supportive filler and some if not all are manually adjustable to create more or less support when more or less filler is added to or subtracted from compartments.

A pillow with a core which has multiple compartments that are either permanently affixed to each other in alignment or are structured into adjoining cells that are removable entirely.

A pillow which has ends may be affixed to each other to create a torus shape to stabilize the user's head if desired.

A pillow with an adjustment string for compressing or elongating the pillow lengthwise if desired.

A pillow with an internal and external case that fasten together so that the case does not fall off during use.

A pillow with a core that is cased within one or more materials including but not limited to those that are silky, plush, padded and encourage movement between the material(s) encasing the core and the external casing while simultaneously discouraging migration of the filler inside the core compartments.

A pillow may be used in conjunction with another pillow to further promote positions of comfort and alignment for both the face and body.

A pillow used for sleeping more comfortably and waking up with less or no pain, stiffness, or soreness from staying in one position for an extended period of time while laying down, either resting or sleeping. This pillow may be used for the purpose of training the user to sleep on their back for health reasons such as recovery from surgery or injury, or cosmetic reasons such as mitigating wrinkles, sagging skin and other signs of aging. This pillow may also be used for neck/head support comfort during travel. This pillow may be used for the purpose of sleeping one's side during pregnancy to allow for increased circulation and comfort for mother and child. This pillow may be used for support and relaxation during a body work service such as massage or acupuncture. This pillow may be used to decrease fatigue during sex by providing support for various sexual positions. This pillow may also be used for relieving a user of the heightened perception of sound (tinnitus) while in the sleep position.

A configurable pillow comprises multiple segments attached contiguously to form an elongated shape and removable filling for filling the segments. The segments include openings to allow filling to be added or removed from individual segments. The segments may be permanently attached to each other, or may be detachable. Often the pillow includes a case for containing the segments. The case may attach to one of more of the segments to keep the segments from shifting excessively.

The configurable pillow may include an attachment (like ties, snaps, buttons, a zipper, hook and loop material, etc.) to allow the ends of the pillow to be joined to form a closed loop forming a generally torus shape.

Since the segments can have filling added or removed, the segment openings may include attachments to hold the segment openings closed when the pillow is in use (see some examples of attachments above). As an alternative, the segment openings may be formed with one side of the opening overlapping the other side of the opening when filling is not being added or removed from the segments. This will tend to hold the filling in place when the opening is not deliberately pulled open.

The pillow may include a drawstring mechanism configured to shorten the pillow when a drawstring is pulled, and to allow the pillow to lengthen when the drawstring is released.

The pillow may be formed of material that allow the segments to slide within the cover to some extent. For example, the amount of friction between the case and the segments can be less than the friction between the case and a user.

The outer surface of the case may comprise a split fiber fabric, like faux fur or plush.

The pillow may be configured in a number of ways to support a user. The pillow may be attached at the end to form a ring and the user might lie on their side or back within the ring. Segments are more or less filled to meet the needs of the user. For example, many people want less filling under their necks. Or a pregnant user may want less filling under her abdomen.

It is helpful to have two configurable pillows. For example, a larger body pillow to support the user's body and a smaller head or face pillow to support the user's head or face. The face pillow may form a ring to go under the user's head or be straightened to allow the user to rest their face against it.

The user may remove pressure from brow, cheek and/or mandible areas by resting the user's face against the face pillow while in a c or s shape. Or the user may displace the user's ear from the pillow for relief from tinnitus by resting the user's face against the face pillow while in a torus, c or s shape.

### BRIEF DESCRIPTION OF THE DRAWINGS

FIG. 1 is a front view of the pillow in an elongated position.

FIG. 2 is a front view of the pillow of FIG. 1 showing the inner compartments of the pillow.

FIG. 3 is a front view of three compartments having apertures.

FIG. 4A is a close up side view of the pillow.

FIG. 4B is a detail close up of the external pillow case aperture.

FIG. 5 is a front view of the pillow in an S shape.

FIG. 6 is a front view of the pillow in a U shape.

FIG. 7 is a front view of the pillow in an O shape.

FIG. 8 is a front view of using both a face and body size pillow in conjunction.

FIG. 9 and FIG. 10 are illustrations of the O and U configurations where the center compartment has been emptied of some filler.

FIG. 11 is an illustration of the aperture of a core segment of the pillow receiving fill during an adjustment of the padding level.

FIG. 12 is an illustration of an inner case being tied to an inside-out external case so that it does not migrate off the pillow during use.

FIG. 13 is a front view of the pillow in an elongated position with the drawstring device in a loosened configuration.

FIG. 14 is a front view of the pillow in a compressed position with the drawstring device tightened.

FIG. 15 is a close-up view of the ends of the external case that fastens together with a magnetic device, hook and loop fastener, tie or some other fastening structure or system to create a torus shape.

FIG. 16 illustrates one position for the body pillow that provides support under the knees and for the hip flexors.

FIG. 17 illustrates one position for the body pillow that supports the users head, hips, knees and back.

FIG. 18 illustrates one position for the body pillow that supports the users head, hips and back.

FIG. 19 shows a larger body pillow and a smaller face pillow used in a side sleeping position.

FIG. 20 shows a larger body pillow and a smaller face pillow used in a supine sleeping position where the face pillow is providing stabilization of the head to one side.

FIG. 21 shows a larger body pillow and a smaller face pillow used in a supine sleeping position where the face pillow is arranged on a torus shape, providing stabilization of the head on all sides.

### DETAILED DESCRIPTION OF THE INVENTION

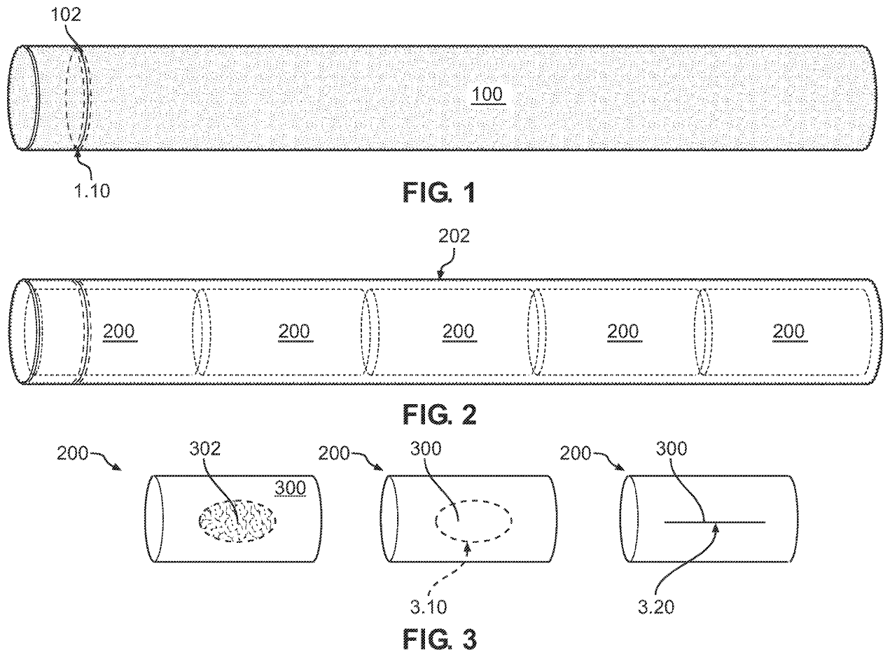

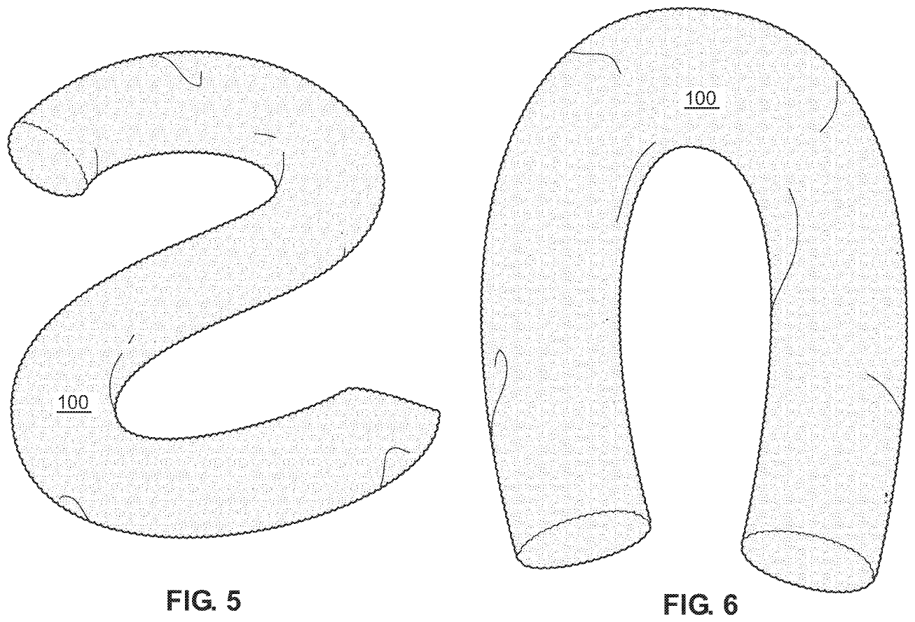

FIGS. 1 through 4B show the basic components of pillow 100 design. FIGS. 5 through 8 show just a few of the configurations that pillows 100 may be arranged into.

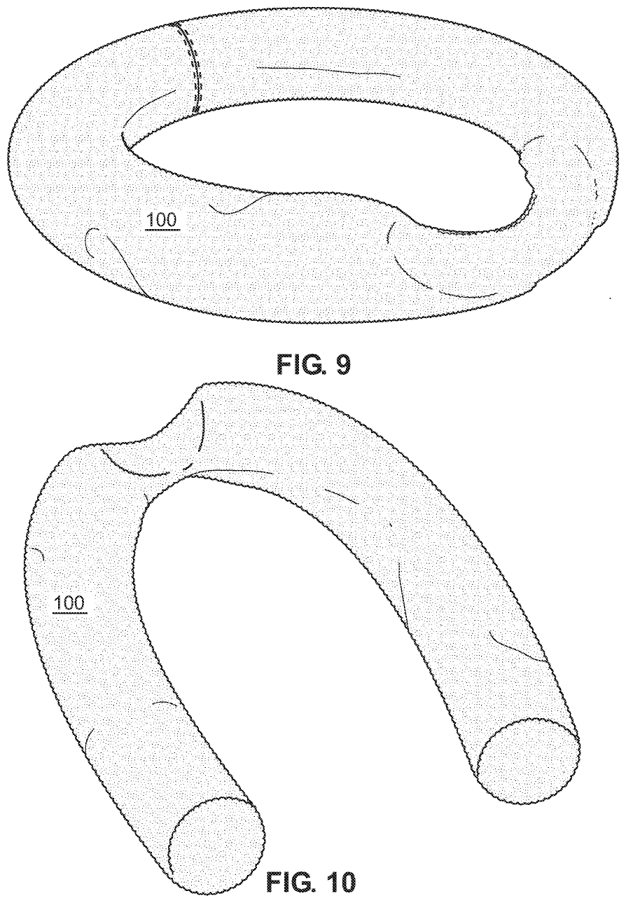

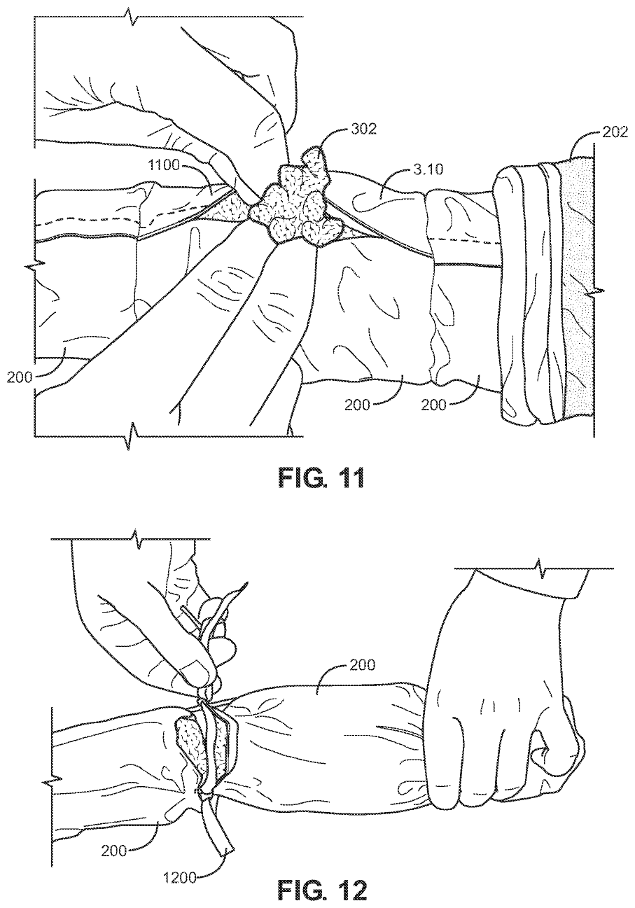

FIGS. 9 and 10 show just a few configurations where the inner supportive filler 302 has been changed. FIG. 11 shows a mechanism for adjusting an inner segment.

FIG. 12 shows a mechanism for keeping an external pillowcase in place on the pillow.

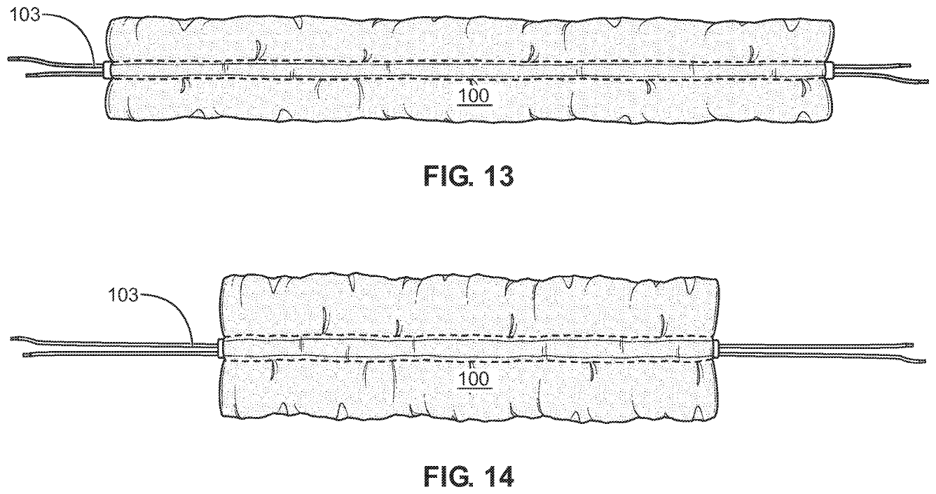

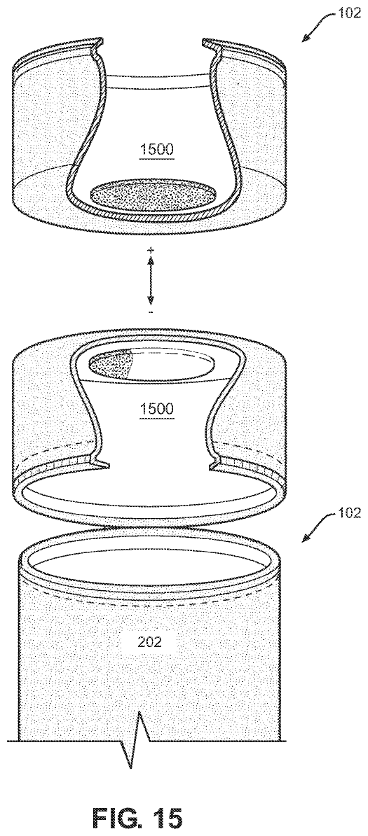

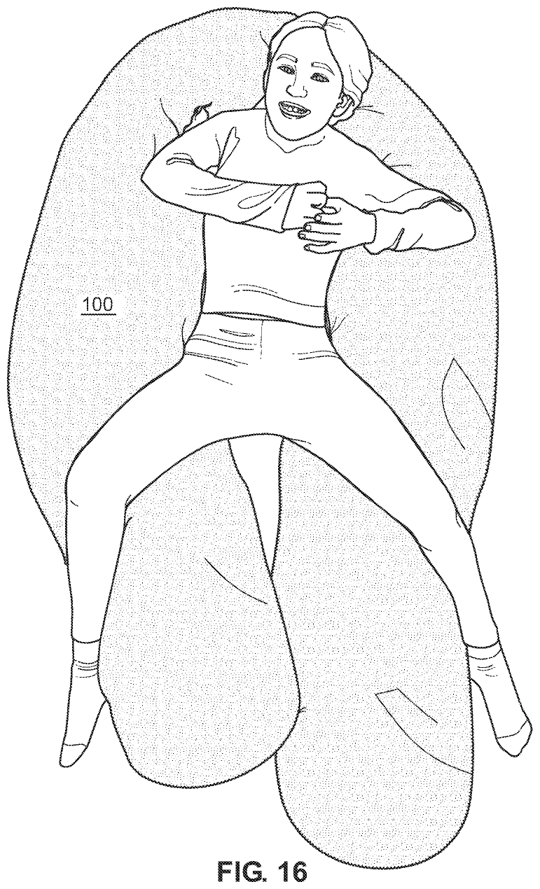

FIGS. 13 and 14 show a pillow with drawstrings, in an extended and a contracted configuration. FIG. 15 shows pillow ends 1500 being connected. FIGS. 16-21 show various configurations of one or more pillows 100 in use.

FIG. 1 is an illustration of pillow 100 in an elongated position. 1.10 indicates an aperture 102 in a closed position. Pillow 100 may vary in size depending on the intended area of use such as the face, body part or entire body. The inner compartments of pillow 100 are shown in FIG. 2.

FIG. 2 is an illustration of inner compartments 200 that either join together with some releasable coupling device or are permanently attached together (e.g. sewn in place). Compartments 200 are disposed within outer case 202 to form the entire pillow 100. If compartments 200 are not permanently joined, one or more may be entirely removed by the user as desired. The coupling device between compartments 200 could comprise something commonly used to join two material bodies including but not limited to string, magnets or hook and loop connection.

FIG. 3 is a front view of three compartments 200 having apertures 300. 3.10 indicates aperture 300 in an open configuration. 3.20 indicates aperture 300 in a closed position. Aperture 300 is a device that a user may open and close easily such as a zipper. The aperture may not require a closing device, if the fabric is sewn with an open section that overlaps enough to maintain the fill inside without closure (see FIG. 11). Filler 302 may be added or removed when aperture 300 is open.

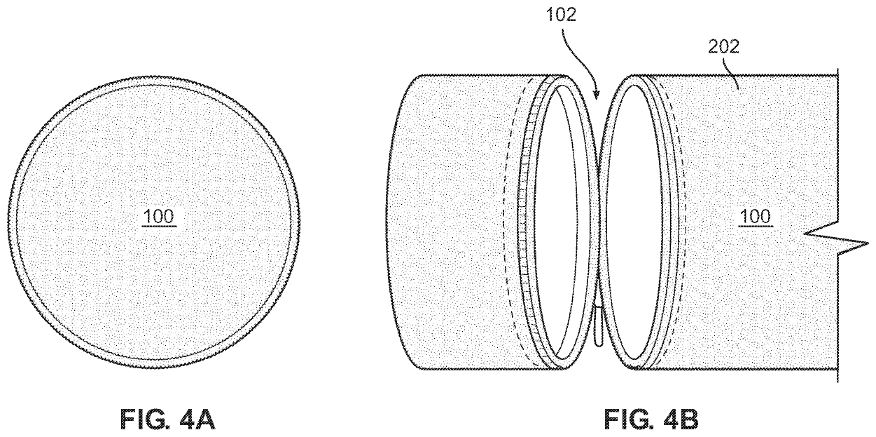

FIG. 4A is a side (end) view of pillow 100.

FIG. 4B is a close up of an aperture 102 in an open position on the exterior 202 of the pillowcase. One or both sides may or may not have an opening device such as a zipper to close aperture 102. Additionally, the inner core may join to one or both sides of the removable casing material with a string, magnet, hook and loop, or some other device to keep the pillowcase in place (See FIG. 12).

FIG. 5 is an illustration of pillow 100 in an S shape which may be desired for use with the face as to accommodate areas prone to creasing such as the eye and jaw areas.

The forehead, temple and under chin area will make the most contact with the pillow thereby allowing the cheekbone and jaw area to be free of heaviest pressure.

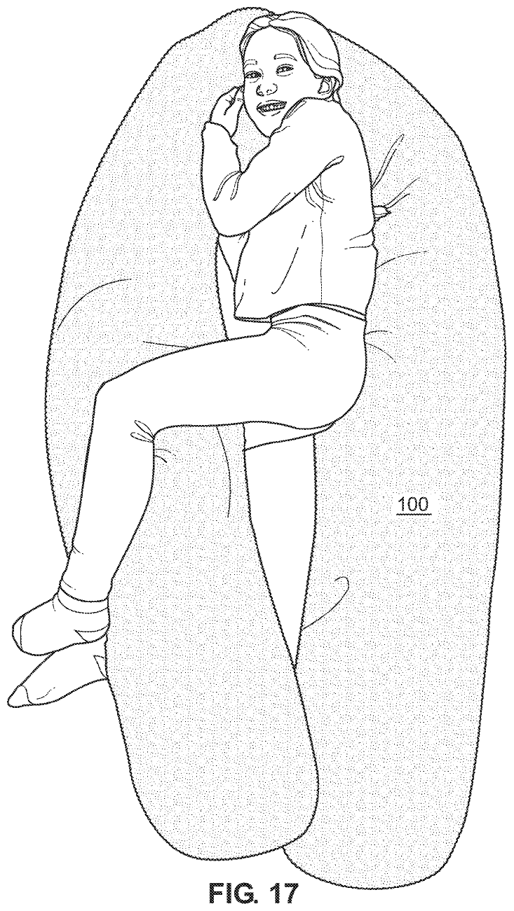

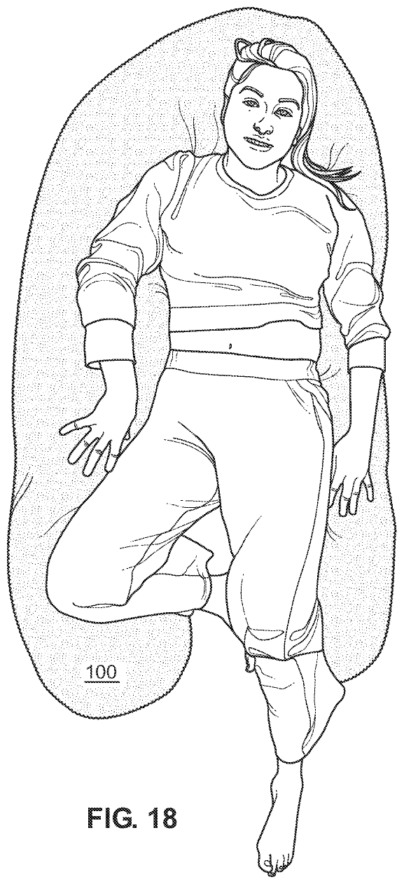

FIG. 6 is an illustration of pillow 100 in a U shape which may be desired for the face to stabilize the head and neck when a user is laying on their back. It may also be desired for the body to encourage the user to sleep on their back and allow them to either prop their feet up on the ends or use as a bolster under the knees to relieve pressure on the lower back (See FIGS. 16 and 18). It also allows the user to hold one side of the body pillow 100 between their knees to relieve back and hip pressure while side sleeping (See FIG. 17).

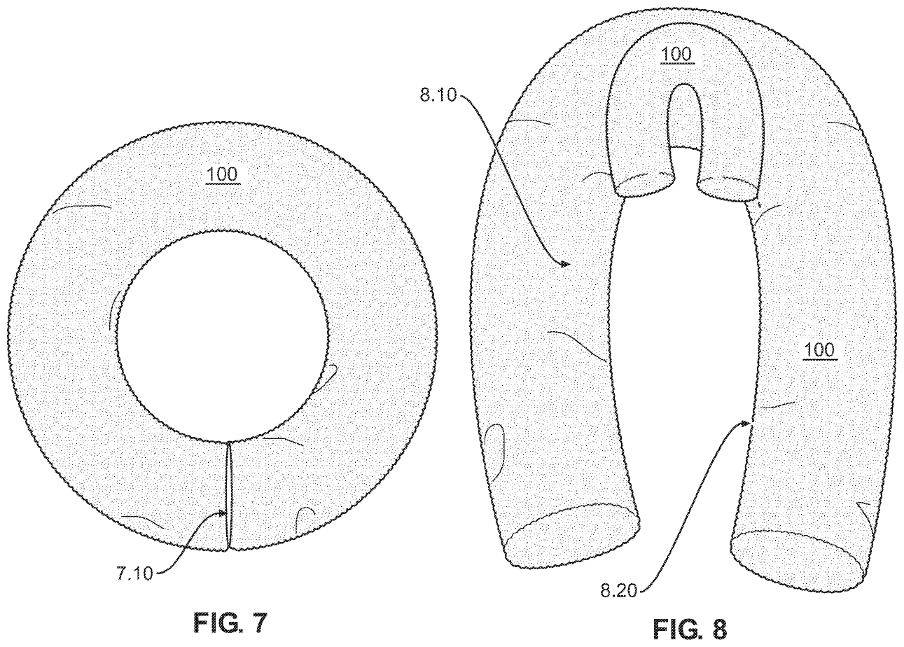

FIG. 7 is an illustration of pillow 100 in an O shape which may be desirable for stabilizing the user's head. 7.10 indicates where the ends of pillow 100 are joined via, e.g. a zipper, magnet, or hook-and-loop fastener.

FIGS. 5, 6 and 7 are all illustrative of configurations that allow a user's ear to not come in direct contact with the sleep surface and therefore may mitigate tinnitus during periods of use.

FIG. 8 is an illustration of using both a smaller head/face pillow 100 and a larger body size pillow 100 in conjunction. This allows the user to benefit from the bolstering effects of the body pillow along with the distributed pressure benefits the facial pillow provides. The body pillow 100 will also offer more outer structure to the face pillow 100 if used to externally cradle it. The face pillow and the body pillow may be connected in various ways, such a tying, hook and loop, etc.

FIG. 9 and FIG. 10 are illustrations of the O and U configurations where one or more center compartments 200 have been emptied of some filler 302 for the purpose of allowing the user's neck to be less displaced compared to the head and shoulders. The body sized pillow 100 with center and side compartments 200 may also be emptied of some fill (not pictured). The lower profile of the sides accommodates a side sleeper with a pregnancy or user that wants support between their knees but has smaller hips and is therefore desiring less displacement.

FIG. 11 is an illustration of a core segment 200 compartment being filled or emptied of some filler 302 to accommodate the user's padding amount preference. In this example, the filler 302 is held in place without a closure mechanism in opening 300, because one side of opening 300 overlaps the other side when they aren't pulled apart.

FIG. 12 is an illustration of an attachment (here a tie) that joins an inner and outer case to keep the external case from slipping off the pillow during use.

FIG. 13 is a front view of the pillow in an elongated position with the drawstring device 103. FIG. 14 is a front view of the pillow in a compressed position with the drawstring device 103. Here, pulling drawstring 103 shortens the pillow length and releasing drawstring 103 allows the pillow to lengthen.

FIG. 15 shows pillow 100 ends being connected. Attachment 1500 may comprise ties, magnets, hook and loop, zipper, buttons, snaps, etc.

FIG. 16 shows pillow 100 in a U configuration with a back sleeper. FIG. 17 shows pillow 100 in a U configuration with a side sleeper. FIG. 18 pillow 100 in a U configuration with a different back sleeper position.

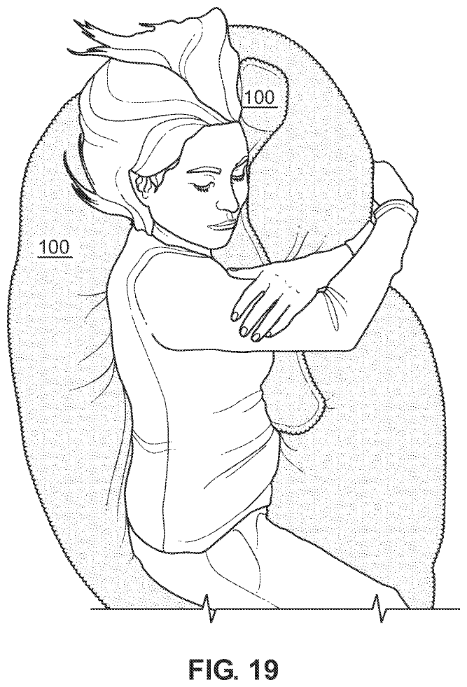

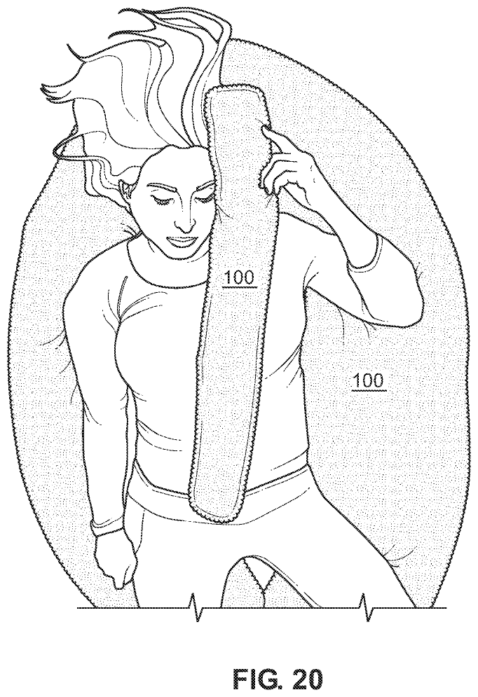

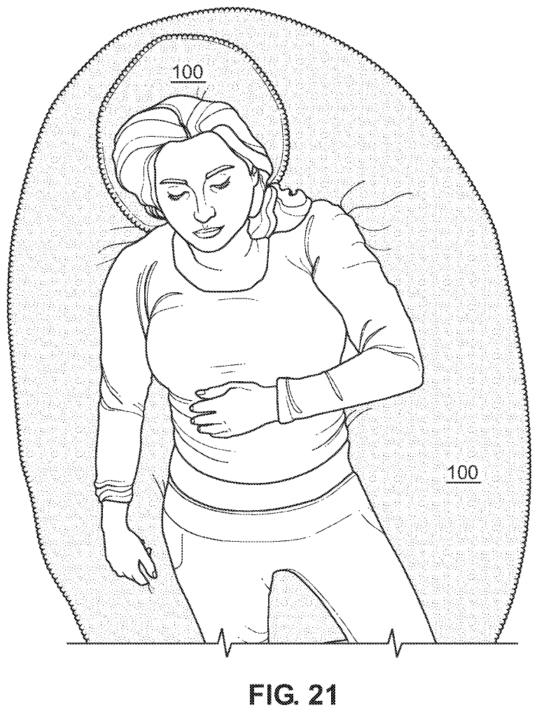

FIG. 19 shows a larger body pillow 100 and a smaller face pillow 100 used in a side sleeping position. Here, face pillow 100 is in an elongated configuration and supports the user's face. FIG. 20 is a similar configuration for a back sleeper. Again, face pillow 100 is in an elongated configuration and supports the user's face. FIG. 21 shows a larger body pillow 100 and a smaller face pillow 100 used in a back sleeping position, with the face pillow forming a torus.

Characterized by its flexibility, length and adjustability, pillow 100 is uniquely designed to accommodate users with various needs, body types and preferences. Other pillows, especially those that are long and thin tend to become uneven where the filler 302 moves and clumps together or migrates away in some areas entirely. This issue is addressed with the continuously aligned compartments 200 that house a shorter holding space for filler 302 so that the migration of filler 302 is less of a factor. The shape of pillow 100 also lends itself to being used in conjunction with outer pillowcases that further the goal of even padding distribution and also allows the inner core to move relatively freely of friction inside the case so that delicate areas of skin are not pulling on the outer material (not pictured).

Pillow 100 is adjustable at the inner compartment 200 level, allowing for adding and subtracting filler 302—and therefore support—for specific areas. Compartments 200 may even be entirely removable or more compartments 200 may be added to accommodate a user's preferences for a longer or shorter version. A longer version may be preferable for a user with larger breasts whom desires to mitigate wrinkles in the décolletage area. A tightening or lengthening apparatus may also allow a user to constrict or elongate pillow 100, in effect also creating a higher or lower level of firmness or softness (see FIGS. 13 and 14).

Due to this flexibility—both material and transformational, pillow 100 allows users to alleviate points of pressure on and in the body. When used consistently over time as a facial pillow, it may aid the mitigation of signs of aging such as sagging skin, deep creases and surface wrinkles. When used for the body, this pillow may give relief to users that suffer from chronic pain in the body or temporary discomfort such as while healing from injury, surgery or during pregnancy. It also may be used as a travel pillow that provides a variable level of support for the user's neck and head. It may also provide relief for users with tinnitus by mitigating the sound that is amplified when a user's ear is flush with a standard sleep surface. It may also provide support, comfort and relaxation for body work services and sexual positions.

The unique design of this pillow may also aid users in changing and maintaining desirable sleep positions that they are not formerly used to. There are a number of reasons why users may want or need to sleep in different positions. For example sleeping supine on one's back is arguably best for mitigating the effects of aging on the face. Or sleeping on one's side is commonly considered preferable for women that are pregnant. Or one may be healing from an injury or surgery and may want to remove pressure from certain body parts. When both the face pillow and body pillow are used together in combination, they work together to provide more support and structure to the sleep (or otherwise laying) position and may help the user train themselves away from laying prone on their stomach and/or downward facing side sleeping which can cause unfavorable results for the face and body.

What is claimed is:

1. A configurable pillow comprising:
at least three elongated segments attached contiguously along short sides of the segments to form an elongated shape; and
removable filling for filling the segments;
wherein the segments include openings to allow filling to be added or removed from individual segments.

2. The configurable pillow of claim 1 wherein the segments are permanently attached together.

3. The configurable pillow of claim 1 wherein the segments are detachable.

4. The configurable pillow of claim 1 further comprising a case containing the segments.

5. The configurable pillow of claim 4 wherein at least one segment is attached to the case.

6. The configurable pillow of claim 4, further comprising an attachment at each end of the case to allow formation of a closed loop.

7. The configurable pillow of claim 4 including attachments configured to hold the segment openings closed when filling is not being added or removed from the segments.

8. The configurable pillow of claim 4 wherein the segment openings have two sides and are formed with one side of the opening overlapping the other side of the opening when filling is not being added or or removed from the segments.

9. The configurable pillow of claim 4, further comprising a drawstring mechanism configured to shorten the pillow by compressing segments when a drawstring is pulled, and to allow the pillow to lengthen when the drawstring is released.

10. The configurable pillow of claim 4 wherein an amount of friction between the case and the segments is less than friction between the case and a user.

11. The configurable pillow of claim 4 wherein an outer surface of the case comprises a split fiber fabric.

12-14. (canceled)

15. A method of providing a configurable body pillow comprising the steps of:
providing at least three elongated segments attached contiguously along short sides of the segments to form an elongated shape;
providing openings in the segments to allow filling to be added or removed from individual segments; and
housing the segments within a cover.

16. The method of claim 15 further including the step of adding filling to or removing filling from at least one segment.

17. The method of claim 15 further comprising the step of joining ends of the cover to form a torus shape.

18. The method of claim 15 further comprising the steps of:
providing a second smaller configurable face pillow having at least three segments contiguously attached to form an elongated shape with openings in the segments to allow filling to be added or removed from individual segments;
supporting a user's body with the body pillow; and
supporting the user's head with the face pillow.

19. The method of claim 18 wherein the step of supporting the user's head with the face pillow includes the steps of:
attaching ends of the face pillow to form a torus shape;
placing the face pillow along the body pillow; and
resting the user's head on the face pillow.

20. The method of claim 18 wherein the step of supporting the user's head with the face pillow includes the steps of:
placing the face pillow adjacent to a user's face; and
leaning the user's face against the face pillow.

21. A configurable pillow comprising:
at least three segments attached contiguously to form an elongated shape;
removable filling for filling the segments; and
a drawstring mechanism configured to shorten the pillow by compressing segments when a drawstring is pulled, and to allow the pillow to lengthen when the drawstring is released; and
wherein the segments include openings to allow filling to be added or removed from individual segments.

22. The configurable pillow of claim 21 further comprising a case containing the segments.

23. The configurable pillow of claim 21 wherein at least one segment is attached to the case.
